(19) United States
(12) Patent Application Publication
(10) Pub. No.: US 2006/0109930 A1
(43) Pub. Date: May 25, 2006

(54) Method and device for deriving a predistorted signal

(76) Inventors: Robert O'Sullivan, Cork (IE); Patrick J. Pratt, Mallow (IE); Daniel B. Schwartz, Scottsdale, AZ (US); Matthew D. Traudt, Olathe, KS (US); Michael W. O'Brien, Youghal (IE)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/981,800

(22) Filed: Nov. 5, 2004

(30) Foreign Application Priority Data
Nov. 5, 2003 (GB) GB 0325852.2

(51) Int. Cl. H04L 25/03

(52) U.S. Cl. 375/296

(57) ABSTRACT

A device for deriving a predistorted signal for provision to a non-linear element comprising memory for storing a plurality of data samples that define a segmented approximation of distortion curve characteristics for the non-linear element where the plurality of data samples define the segment boundaries and a predistortion module for determining within which segment of a plurality of segments a predistortion input signal would provide an output signal substantially equal to an idealized output signal and deriving a predistortion signal based upon the segment boundaries.

The present invention relates to a method and device for deriving a predistorted signal.

Many processes require linear amplification or control, in such circumstances a non-linear response will invariably degrade the performance of such processes. Accordingly, there is a need to minimise or remove non-linear distortion effects.

One solution is to ensure that the appropriate circuit is designed to exhibit linear characteristics over the operation range. This, however, generally results in a relatively high power consumption, which typically creates a trade off between specification compliance, design effort, occupied circuit area and power consumption.

Another solution is the classic feedback arrangement, which involves comparing an output signal to the corresponding input signal, via a feedback loop, and making appropriate corrections to the input signal in real time. However, in many applications the bandwidth of the feedback loop used to perform this correction is insufficient and thus can not allow correction to an input signal in sufficient time to allow normal operation of the device.

Another solution to minimise non-linear amplification effects is the use of predistortion. Predistortion can be regarded as a feedforward control system that involves replacing an input signal with a predistorted signal (i.e. an inverse distortion signal) prior to the input signal being input into a non-linear system such that the resultant output from the non-linear system appears linear.

There are many types of predistortion; some use a derived equation to model non-linearities, whereas others store a set of data points in a look-up table to approximate the non-linear transfer function.

In the case of a dynamic or self-calibration system the process for measuring the distortion of a given system is called training. This involves exercising the system over a range of interest and noting its response over this range. The normal operation of the system must usually be suspended during training as it is under the control of the predistortion system. As the bandwidth of the feedback path can be much lower than that of the forward path this training time can be significant from the point of view of normal operation.

In particular one predistortion technique generates a look-up table that contains inverse gain characteristics of a device with respect to a given signal input value where the appropriate inverse gain is multiplied with the input signal to produce a predistorted output signal. This technique, however, requires multiple correction/training iterations to determine an accurate look-up table. For example, an input test signal that has been input to determine an appropriate gain correction value for the look-up table is corrected with an inverse gain but this additional inverse gain value merely results in the input signal being given a different input value that correspondingly also needs to be corrected with an inverse gain appropriate to the new signal input value. Consequently, the first gain correction only moves the signal gain towards the required gain value and not to the desired gain value. Consequently, the generation of an accurate look-up table that contains inverse gain characteristics of a device can require multiple iterations of feedback to produce during training and correspondingly can be time consuming.

In accordance with a first aspect of the present invention there is provided a device for providing a predistorted signal according to claim 1.

This provides the advantage of allowing a predistorted value to be derived in one iteration without requiring multiple step training.

In accordance with a second aspect of the present invention there is provided a method for providing a predistorted signal according to claim 10.

An embodiment of the invention will now be described, by way of example, with reference to the drawings, of which:

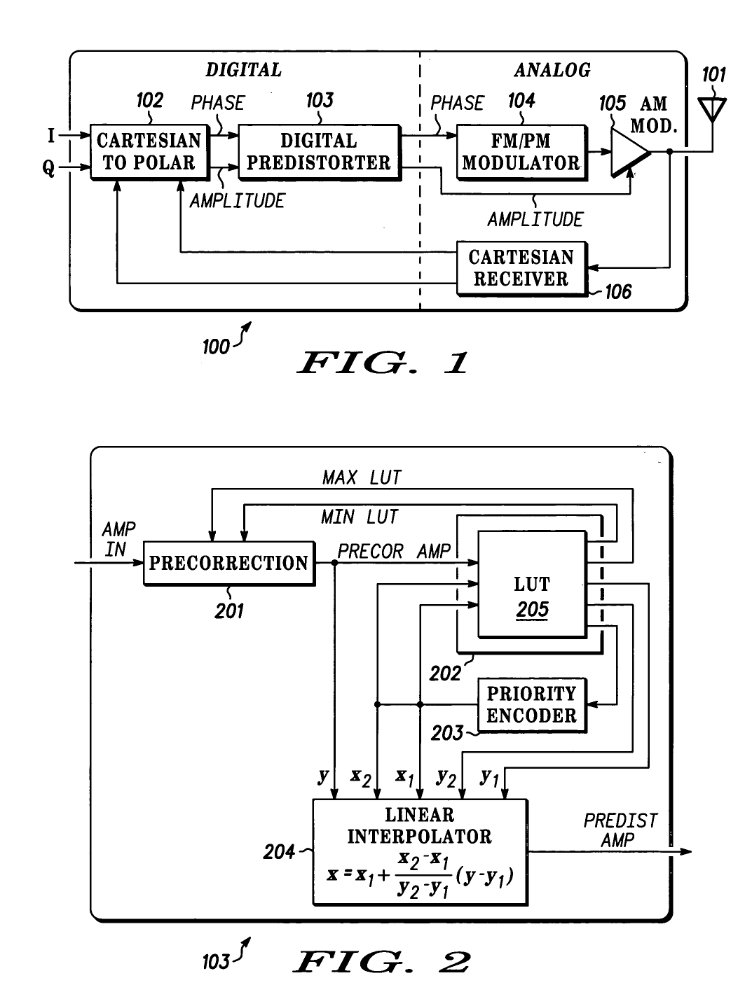

FIG. 1 illustrates a polar transmitter according to an embodiment of the present invention;

FIG. 2 illustrates a predistortion module according to an embodiment of the present invention;

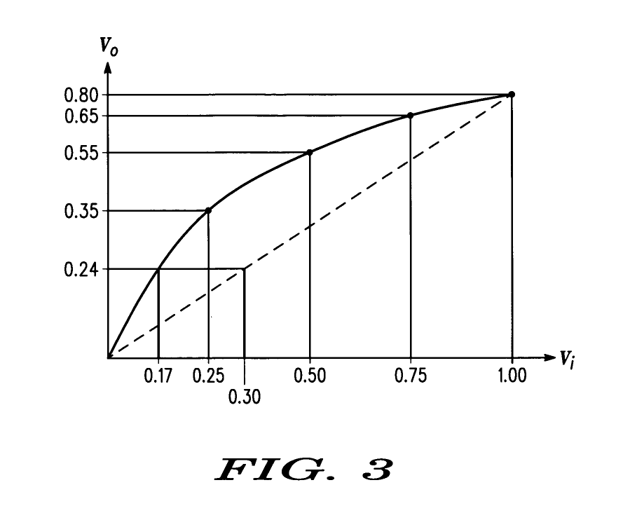

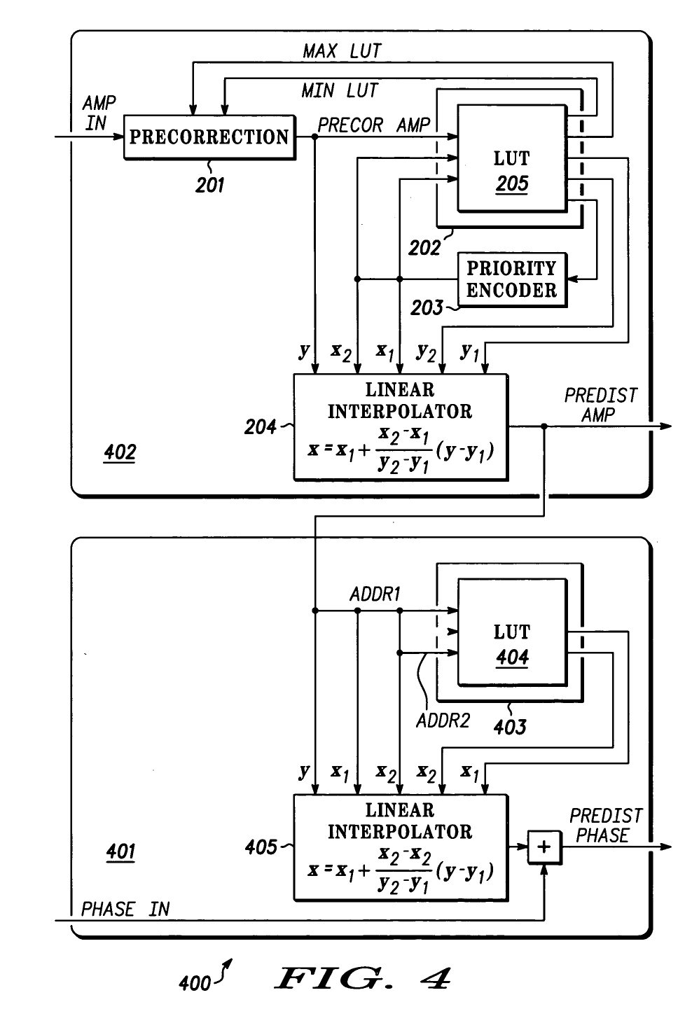

FIG. 3 illustrates a segmented approximation of distortion curve characteristics for a non-linear element;

FIG. 4 illustrates a predistortion module according to a second embodiment of the present invention.

FIG. 1 shows a polar transmitter 100 suitable for use in a wireless system (not shown), for example within an EDGE mobile phone system, coupled to an antenna 101.

The polar transmitter 100 includes a Cartesian to polar converter module 102, a digital predistortion module 103, a frequency modulator/phase modulator FM/PM module 104, an amplitude modulator AM module 105 and a Cartesian receiver 106.

The Cartesian to polar converter module 102 is arranged to receive separate I and Q digital base band signals from a base band module (not shown) and convert the I and Q signals into corresponding digital polar signals, as is well known to a person skilled in the art. The digital polar signals, which correspond to an AM component and a PM component, are provided to the digital predistortion module 103 via separate inputs. The digital predistortion module 103 determines an appropriate predistorted value for both the AM and PM signal components to compensate for the non-linear effects of the polar transmitter 100, as described below.

On determination of a suitable predistorted value for both the AM and PM signal components the digital predistortion module 103 replaces the AM and PM polar input signals with the respective predistorted signal, which are output to the AM module 105 and FM/PM module 104 respectively.

The AM modulation process distorts both AM and PM signals. However, the removal of the AM distortion is more difficult, while removal of AM-on PM distortion is easier as it is possible to tweak the PM value without causing PM to be subject to a different distortion value. Accordingly, the embodiment according to FIG. 2 will only describe the process for deriving an appropriate predistorted value for AM signal values, where any suitable process for determining PM predistortion values can be used. FIG. 4 illustrates a second embodiment in which both AM and PM predistortion is performed.

The predistorted PM signal is output from the digital predistortion module 103 to the FM/PM modulator 104. The FM/PM modulator 104 differentiates the PM signal to convert the PM signal into a FM signal, which is used to control the frequency of an oscillator (not shown) operating within an RF band appropriate to the wireless system within which the polar transmitter 100 is operating. The resulting RF signal is fed into the AM modulator 105.

The predistorted AM signal is output from the digital predistortion module 103 to the AM modulator 105 where the AM control signal modulates the amplitude of the sinusoid at the output of the AM modulator 105.

Additionally, the output from the AM modulation module 105 is fed back to the Cartesian to polar module 102, via the Cartesian receiver 106, where the Cartesian receiver 106 converts the outputted polar signals back into Cartesian I and Q signals.

The purpose of the feedback loop is to allow the digital predistortion module 103 to characterise/model the system, as described below, thereby allowing the predistortion module 103 to operate as a feed forward system during normal operation. The feedback loop is only activated during training and as such can have a lower bandwidth that the forward path and consequently can be made with less of a cost/space overhead.

FIG. 2 shows the digital predistortion module 103. The digital predistortion module 103 includes a precorrection unit 201, a memory module 202, a priority encoder 203 and an interpolator 204.

The precorrection module 201 has an input for receiving an AM signal from the Cartesian to polar module 102 and an output coupled to a first input on the memory module 202, which incorporates a look-up table LUT 205, and to a first input of the interpolator 204. The output of the precorrection module 201 provides a pre-corrected AM signal to both the memory module 202 and the interpolator 204. The precorrection module 201 modifies the amplitude of the input signal to provide the effect of equalising the gain of the feed forward path (i.e. input) to the feedback path (i.e. output) of the polar transmitter over the selected operational range. This has the effect of transposing the gain of an input signal to that of the gain of an idealized output (i.e. the gain that the output signal would have for a linear amplification system). This can also be considered as moving and scaling the input gain (x axis) verse output gain (y axis) graph.

If the dynamic range of the non-linear polar transmitter 100 could be guaranteed to encompass the input signal swing range the precorrection module 201 could be omitted from predistortion element 103.

The memory module 202 has first and second outputs that are coupled to a second and third input on the precorrection module 201 respectively for providing a minimum look-up table value and a maximum look-up table value to the pre-correction module 201 to allow the precorrection module 201 to know the available dynamic range of the system. The memory module 202 has a third output coupled to an input on a priority encoder 203. The memory module 202 also has a fourth output, a fifth output and a sixth output that are coupled to a second input, a third input and a fourth input respectively on the linear interpolator.

The priority encoder 203 has an output that is coupled to both a second input on the memory module 202 and a fourth input on the linear interpolator 204.

The look-up table 205 within the memory module 202 stores the gain characteristics of the polar transmitter 100, as described below.

The priority encoder 203 is arranged to select the sample points stored in the look-up table 205 that correspond to the sample points that neighbour the value of a received input symbol. For example, the LUT 205 can contain a bitmap of the elements of the LUT 205 that are above/below a value presented to the input of the LUT 205.

The interpolator 204 makes an interpolation between the neighbouring sample points selected by the priority encoder 203 to determine the predistorted value. The interpolator 204 outputs the predistorted value to the AM modulation module 105 via an output.

As stated above, the digital predistortion module 103 is arranged to generate a predistorted PM signal in a conventional manner and will not be described within this embodiment, shown in FIG. 2.

In a first mode/phase of operation, off-line training/calibration of the polar transmitter 100 is performed. The off-line training/calibration takes the form of sending a number of symbols through the polar transmitter 100 where the symbols are selected to have different amplitudes that drive the polar transmitter 100 through its full operational range. Accordingly, the distortion characteristics of the polar transmitter 100 are found at discrete points over the full operational range of the transmitter 100.

The measured characteristics (i.e. the signal values that would need to be input into the polar transmitter to generate a linear output) are stored in the look-up table 205 at a location that corresponds to the signal input value. Consequently, the look-up table 205 contains information that corresponds to an approximation of the inverse of the input verses output characteristics curve for the polar transmitter 100, similar to that shown in FIG. 3. That is to say, the look-up table corresponds to an input-verses-output graph in which the x-axis (i.e. the address) corresponds to the input values and the y-axis (i.e. the addressed content) corresponds to the measured output values.

The number of sample points chosen as part of the training/calibration process will depend upon the non-linearity characteristics of the polar transmitter.

Once the look-up table 205 has been populated with the non-linear characteristics of the polar transmitter 100 for the selected sample points the predistortion module 103 is ready to enter into its normal/operational mode of operation in which a predistortion output signal is derived for an input signal.

On receipt, by the precorrection module 201, of an input symbol the precorrection module 201 transposes the input signal amplitude to a value that will be attainable by the non-linear system by using the maximum and minimum output symbol amplitudes that are stored in the look-up table 205 during the training/calibration mode as the end points for the linear graph. The precorrection module 201 receives the maximum and minimum output symbol amplitudes from the memory module 202 via the second and third inputs respectively.

As stated above, the precorrected symbol amplitude is then provided to the memory module 202 and the interpolator 204.

The memory module 202 is arranged to compare the amplitude of the precorrected symbol with the contents of the look-up table 205, where the contents of the look-up table 205 corresponds to the amplitudes of the output symbols output during the training/calibration phase. The results of the comparison are supplied to the priority encoder 203, where the priority encoder 203 is arranged to identify the addresses of the two adjacent sample points that contain the amplitudes of the output symbols that straddle (i.e. neighbour) the precorrected symbol.

The two identified look-up addresses define the segment of the predistortion characteristics curve, determined during the training/calibration mode, within which the correct predistortion value must exist to provide an appropriate output signal from the polar transmitter 100 to correct for non-linearities of the transmitter 100.

On identifying which two look-up table addresses contain the neighbouring output values the priority encoder 203 instructs the memory module 202 to supply these two addresses and their contents to the interpolator 204.

Knowing the boundaries of the segment of the predistortion characteristic curve the interpolator 204 determines the predistorted value using linear interpolation between the boundaries where, for the purposes of this embodiment, the equation is given by:
x=x₁+Δx/Δy(y−y₁)

where:

x₁ is the lower look-up table address;

Δx is the difference in interpolation region address;

Δy is the difference in the look-up table contents;

(y−y₁) is the difference between the output and the lower stored output captured in the look-up table.

By way of illustration a simplified example is shown below, with reference to FIG. 3.

During the training/calibration mode four symbols of different amplitudes are input into the polar transmitter 100, where the first symbol has an amplitude of 0.25, the second symbol has an amplitude of 0.50, the third symbol has an amplitude of 0.75 and the fourth symbol has an amplitude of 1.0. The measured output value of the first symbol is 0.35, the measured output value of the second symbol is 0.55, the measured output value of the third symbol is 0.65 and the measured output value of the fourth symbol is 0.8.

These values are used to populate the look-up table 205 during the training/calibration phase where the input values are used as the look-up table addresses and the output values are used as the stored values associated with the address. Consequently, the look-up table has the following information:

LUT (1)=0.8, LUT (0.75)=0.65, LUT (0.5)=0.55, LUT (0.25)=0.35, LUT (0)=0

During the normal/operation mode a symbol is input into the predistortion module 103, which for the purposes of this example has a amplitude of 0.3.

The precorrection module 103 calculates an intermediate output amplitude that will result in a polar modulator output that is both within the attainable range of operation, and results in a effective system gain that is achievable over the entire range of interest. For the purposes of this embodiment it is assumed that the precorrection module only carries out gain compression/expansion; consequently the equation is given by:
Precorrected amplitude=MA×AS/AT

where:

MA is the maximum amplitude in the LUT;

AS is the amplitude of received symbol;

AT is the maximum amplitude that was used during training.

Correspondingly, the precorrected symbol amplitude is given by:
0.8×0.3/1=0.24

The precorrection module provides the precorrected symbol amplitude of 0.24 to the memory module 202. The memory module 202 compares the precorrected symbol value with each of the stored look-up table values with the priority encoder 203 determining between which two LUT locations the received symbol value falls, which in this example, as the precorrected symbol values fall between the output values of 0 and 0.35, must be between the look-up table addresses of 0 and 0.25.

The memory module 202 passes the look-up table address information and associated stored amplitude data to the interpolator module 204 which calculates the predistortion symbol value that would provide an output gain of 0.24 using the linear interpolation equation described above, where x₁, the lower look-up table address, is 0; Δx, the difference in interpolation region address, is 0.25-0; Δy, the difference in the look-up table contents, is 0.35-0; and (y−y₁), the difference between the output and the lower stored output captured in the look-up table, is 0.24-0. Accordingly:
x=0+0.25/0.35×0.24=0.17

Therefore, the predistorted symbol has a value of 0.17. Once subject to the distortion of the polar transmitter this symbol will result in an output of 0.24 (as determined during training). Once the system gain (0.8) has been taken into account it can be seen that this system demonstrates linear transfer characteristics and will be able to do so for any input value in the specified range of interest (i.e. 0 to 1).

Thus, in summary a plurality of data samples define the segment boundaries. A predistortion module determines within which segment of a plurality of segments a predistortion input signal would provide an output signal substantially equal to an idealised output signal. This is performed in a single-step segmented LUT with indirect indexing/determination of a segment, where a predistorted signal is derived based upon the segment boundaries.

FIG. 4 illustrates a second embodiment of the digital predistortion module 400 where the same reference numerals are used for similar features shown in previous figures.

The predistortion module has a PM predistortion element 401 coupled to the output of an AM predistortion element 402 for correcting for AM-on-PM distortion.

The AM predistortion element 402 has a precorrection module 201, a memory module 202, a priority encoder 203 and a linear interpolator 204, which are arranged and operate as described above.

The PM predistortion element 401 contains a memory module 403 that incorporates a look-up table 404 and an interpolator 405. The memory module 403 could be combined with the AM predistortion element memory module 202.

In the first mode/phase of operation off-line training/calibration of the polar transmitter 100 is performed where the training symbols input into the polar transmitter 100 have different amplitudes, as described above with reference to FIG. 2. The amplitude values are stored in the AM predistortion element look-up table 205, as described above.

The difference between the transmitted phase and received phase for each symbol is stored in the PM predistortion element look-up table 404 where each value is stored at an address determined by the relevant training symbol amplitude, which would be the same address as for the AM predistortion element look-up table 205.

In the normal/operation mode the amplitude of a received symbol is used to derive an address from the PM predistortion element look-up table 404, or the neighbouring addresses where the amplitude does not fall on a stored address.

The look-up table address, or addresses where a value falls between two addresses, are used to determine the phase distortion being removed using the interpolator 405 to generate a predistorted PM signal.

By way of example, if the PM predistortion element look-up table 404 is arranged to have ten elements, from 1 to 10, and a symbol is received with an amplitude of 5.3 then 5 is used as the base address (begin segment) and 6 is used as the end segment. The interpolator 405 adds 0.3, where the value of 0.3 is determined using linear interpolation similar to that described above for the AM predistortion element, onto the contents of 5 to produce an output value.

Accordingly, the PM interpolator 405 operates in the same way as the AM interpolator, however the method for generating the address for the PM predistortion element 401 is simpler than that for the AM predistortion element 402.

It will be apparent to those skilled in the art that the disclosed subject matter may be modified in numerous ways and may assume many embodiments other than the preferred forms specifically set out as described above, for example the above embodiments could be arranged to contain a large look-up table such that the difference in values between the different segments is so small that once a segment is identified interpolation is not required to determine an appropriate predistorted signal, and other forms of interpolation could be used, for example cubic interpolation.

We claim:

1. A device for deriving a predistorted signal for provision to a non-linear element, the device comprising memory for storing a plurality of data samples that define a segmented approximation of distortion curve characteristics for the non-linear element where the plurality of data samples define the segment boundaries and a predistortion module for determining within which segment of a plurality of segments a predistortion input signal would provide an output signal substantially equal to an idealized output signal and deriving a predistorted signal based upon the segment boundaries.

2. A device according to claim 1, wherein the predistortion module includes a priority encoder for determining the determined segment boundaries.

3. A device according to claim 2, wherein the predistortion module includes an interpolator for interpolating between the data samples that define the determined segment boundaries.

4. A device according to claim 1, wherein the memory includes a look-up table for storing the plurality of data samples.

5. A device according to claim 1, wherein the interpolation is linear interpolation.

6. A device according to claim 5, wherein the linear interpolation equation is:
x=x+≢x/Δy(y−y₁)
where:
x₁ is the lower look-up table address;
Δx is the difference between the boundary segment addresses;
Δy is the difference in the contents of the look-up table between the boundary segment addresses;
(y−y₁) is the difference between an idealised output and the contents of the lowest address captured in the look-up table.

7. A device according to any preceding claim, further comprising a precorrection module for equalizing the gain over the operational range of interest for a forward path.

8. A transmitter comprising a device for deriving a predistorted signal according to claim 1.

9. A transmitter according to claim 8 wherein the transmitter is arranged to transmit polar co-ordinate signals.

10. A method for deriving a predistorted signal for provision to a non-linear element, the method comprising storing a plurality of data samples that define a segmented approximation of distortion curve characteristics for the non-linear element where the plurality of data samples define the segment boundaries and determining within which segment of a plurality of segments a predistortion input signal would provide an output signal substantially equal to an idealized output signal and deriving a predistorted signal based upon the segment boundaries.
